(19) United States
(12) Patent Application Publication
(10) Pub. No.: US 2016/0339522 A1
(43) Pub. Date: Nov. 24, 2016

(54) METHOD FOR MANUFACTURING METALLIC OBJECT IN WHICH ADDITIVE MANUFACTURING AND PLASTIC DEFORMATION ARE EMPLOYED IN COMBINATION

(71) Applicant: National Institute of Advanced Industrial Science and Technology, Tokyo (JP)

(72) Inventors: Satoshi KAJINO, Tsukuba-shi (JP); Toshimitsu OKANE, Tsukuba-shi (JP); Yuichi MOTOYAMA, Tsukuba-shi (JP)

(21) Appl. No.: 15/148,097

(22) Filed: May 6, 2016

(30) Foreign Application Priority Data
May 18, 2015 (JP) 2015-101274

(51) Int. Cl. B22F 3/24; B33Y 10/00; B33Y 40/00; B22F 3/105

(52) U.S. Cl. CPC B22F 3/24; B22F 3/1055; B33Y 10/00; B33Y 40/00; B21B 1/46

(57) ABSTRACT

A method for manufacturing one of a group consisting of a plate, a foil, a long object, or a bulk object includes Step 1 of manufacturing a formation object having a plate shape, a foil shape, a long object shape, or a bulk object shape using a metallic powder material by an additive manufacturing, and Step 2 of working the formation object into the plate, the foil, the long object, or the bulk object by a plastic deformation.

### TECHNICAL FIELD OF THE INVENTION

The present invention relates to a method for manufacturing a metallic object. Particularly, the present invention relates to a method for manufacturing a metallic object (plate, foil, long object (wire, bar, rod, or the like), bulk object, or the like) having fine crystal grains in which additive manufacturing and plastic deformation are employed in combination.

Priority is claimed on Japanese Patent Application No. 2015-101274, filed on May 18, 2015, the content of which is incorporated herein by reference.

### RELATED ART

The following methods have been known as methods for manufacturing a metallic object.

(A) Continuous Casting/Semi-Continuous Casting

A melted metal is allowed to flow to a bottomless mold. The mold is cooled, and the melted metal brought into contact with the mold is taken out from a bottom portion of the mold while being cooled and solidified. A rolling roller or the like is installed at a tip of the mold, and the metal is sent while being rolled. Technologies for continuously manufacturing a long object by allowing a molten metal to continuously flow to a mold are continuous casting methods (see Patent Document 1). The cooling rate of the molten metal is not too high. According to the material, a bulk material cannot be continuously sent, and thus a semi-continuous casting method in which a certain length of continuous casting is repeated in a batch manner is also used.

(B) Additive Manufacturing

A powder bed in which a metallic powder is spread is irradiated with laser or electron beams as an energy source, and the metallic powder in the irradiated area is melted. Thereafter, when the irradiation of laser or electron beams is stopped, the metal in the melted area is cooled and solidified. When a predetermined area is subjected to laser or electron beam scanning, only an area to be solidified can be solidified. Thereafter, when a layer of a metallic powder is further spread and laser or electron beam scanning is repeated, the solidified area is accumulated and a tridimensionally-formation object is finally completed. When slice data is produced from CAD data of a designed component and laser or electron beam scanning is performed according to the slice data, a component can be manufactured as designed. Additive manufacturing technologies are as described above (see Patent Document 2 and Patent Document 3).

In addition, the following methods have been known as methods for manufacturing a metallic object.

(C) Plastic Deformation

Technologies for deforming and forming a metallic object into a predetermined shape using a property called plasticity in which a metallic object is permanently deformed when stress is applied to the metallic object and the stress exceeds a certain level are collectively called plastic deformation. The plastic deformation is classified into various methods according to a stress application method, a tool to be used, a shape of a target material, and the like. Hereinafter, rolling, extrusion, and forging will be described as representative examples.

(a) Rolling

Rolling is a manufacturing method in which a plate- or rod-shaped material is held by a pair of tools called a roll, a roll gap having predetermined dimensions is set, and then the material is continuously engaged by rotating the roll to manufacture a plate or the like having a same thickness as the roll gap.

(b) Extrusion

Extrusion is a technology in which a hole having a component shape is formed in the bottom of a tool having a container shape, called a container, a material is put into the container and is pressed from behind the material by a tool called a punch having an outer diameter of the same size as an internal diameter of the container to extrude the material from the hole formed in the bottom of the container, and thus the material is processed into a member having a predetermined shape.

(c) Forging

Forging is a technology in which a material is held in a mold with a void having a predetermined shape formed by cutting the inner sides of a set of split molds and by combining the split molds, and the mold is moved closer thereto to fill the void with the material to thus work the material into a shape.

### PRIOR ART DOCUMENT

### Patent Document

[Patent Document 1] Japanese Unexamined Patent Application, First Publication No. 2013-223887

[Patent Document 2] Japanese Unexamined Patent Application, First Publication No. 2015-38237

[Patent Document 3] Japanese Unexamined Patent Application, First Publication No. H11-347761

### DISCLOSURE OF THE INVENTION

### Problems to be Solved by the Invention

When a long object or the like is manufactured by solidification from a molten state as in the conventional continuous/semi-continuous casting, the cooling rate is not too high, and thus crystal grains grow up to several tens of micrometers. Therefore, productivity is high, but there are problems in that it is difficult to improve mechanical properties of the material, and brittleness is exhibited according to the material.

On the other hand, it is known that in the conventional additive manufacturing, the melting/solidification speed is very high, and thus crystal grains are fine. However, the additive manufacturing is a one-batch manufacturing method. The degree of freedom in the shape is high, but dimensions are limited, and a formation object having a length exceeding a forming area cannot be produced. In addition, in the conventional additive manufacturing, the size of grains of a powder to be spread is an important factor for determining surface roughness condition. Even when the powder is a fine powder in the present, it has a grain diameter of several tens of micrometers, and thus the formation object has poor surface roughness. Although the development of a powder having a smaller grain diameter is also advanced, the finer the powder, the more dangerous it is, and thus it becomes hard to deal with in association with explosion prevention and the like. Technologies for improving the surface roughness by controlling forming conditions and the like are also examined, but there are limitations in improving the surface roughness. In addition, regarding the forming method in which a metallic powder is melted and solidified, a local melting and solidification phenomenon cannot be completely grasped in the present, and thus the melting/solidification phenomenon becomes unstable and it also becomes very difficult to increase dimensional accuracy of the formation object. In the present, it is almost impossible to manufacture a formation object having good surface roughness and high dimensional accuracy only through the additive manufacturing.

There are manufacturing methods in which the above-described (A) Continuous Casting/Semi-Continuous Casting and (C) Plastic Deformation are employed in combination, but there are no manufacturing methods in which the above-described (B) Additive Manufacturing and (C) Plastic Deformation are employed in combination. This is because the additive manufacturing focuses more primarily on forming the shape rather than increasing the mechanical properties of a formation object, and as a post-treatment, it is mainly performed to adjust the shape and the surface roughness through cutting/grinding. It has not been considered at present to improve not only the dimensional accuracy and the surface roughness, but also the mechanical properties of a formation object by using plastic deformation as a post-treatment.

Therefore, an object of the invention is to provide a novel method for manufacturing a metallic object (plate, foil, long object, bulk object, or the like), which simultaneously solves the problems of the continuous/semi-continuous casting and the problems of the additive manufacturing, and has the advantages of both of them.

### Means for Solving the Problem

In order to solve the problems, the manufacturing method of the invention includes manufacturing a formation object from a metallic powder material by additive manufacturing, and manufacturing a plate, a foil, a long object, or a bulk object by subjecting the formation object to plastic deformation such as rolling, extrusion, forging, and the like.

That is, the invention relates to a method for manufacturing a plate, a foil, a long object, or a bulk object, including Step 1 of manufacturing a formation object having a plate shape, a foil shape, a long object shape, or a bulk object shape using a metallic powder material by additive manufacturing, and Step 2 of working the formation object into a plate, a foil, a long object, or a bulk object by plastic deformation.

In addition, in the manufacturing method of the invention, the plastic deformation may be one or a combination of two or more of rolling, extrusion, and forging.

In addition, in the manufacturing method of the invention, dimensions of the formation object of Step 1 may be obtained by near net-shaping the formation object to be dimensions within a working ratio at which the formation object can be worked by the plastic deformation of Step 2.

In addition, the invention relates to a plate, a foil, a long object, or a bulk object which is manufactured by the manufacturing method.

Here, the expression “dimensions within a working ratio at which the formation object can be worked by the plastic deformation” means dimensions in which a final product can be obtained by only minimal plastic deformation (one step forging, one step rolling, or the like), and a shape formed to the dimensions of a final product obtained by applying a strain of approximately 20% to 50%, that is a working ratio in a general one step of plastic deformation.

The gist of the invention is as follows.

(1) A method for manufacturing one of a group consisting of a plate, a foil, a long object, or a bulk object according to an embodiment of the invention includes: Step 1 of manufacturing a formation object having a plate shape, a foil shape, a long object shape, or a bulk object shape using a metallic powder material by an additive manufacturing, and Step 2 of manufacturing the formation object into the plate, the foil, the long object, or the bulk object by a plastic deformation.

(2) In the method for manufacturing one of the group consisting of the plate, the foil, the long object, or the bulk object according to (1), the plastic deformation may be one or a combination of two or more of a rolling, an extrusion, and a forging.

(3) In the method for manufacturing one of the group consisting of the plate, the foil, the long object, or the bulk object according to (1) or (2), dimensions of the formation object of Step 1 may be obtained by near net-shaping the formation object to be dimensions within a working ratio at which the formation object can be worked by the plastic deformation of Step 2.

(4) One of a group consisting of a plate, a foil, a long object, or a bulk object according to another embodiment of the invention is manufactured by the manufacturing method according to any one of (1) to (3).

### Effects of the Invention

According to the invention, it is possible to manufacture a metallic object having a fine crystal microstructure of several micrometers or less and having a plate shape, a foil shape, a long object shape, or a bulk object shape. By virtue of the fine crystal microstructure, a formation object according to the invention is a metallic object markedly improved in strength and ductility and also having extremely high toughness in comparison to conventional metallic objects. In addition, it is possible to manufacture a metallic object having good surface roughness and dimensional accuracy. By using such a metallic object, for example, transmission cases, brake drums, manifolds, and water-cooled cylinder blocks, which are manufactured by aluminum alloy casting, connecting rods, crankshafts, lock arms, and camshafts, which are manufactured by forging, and automobile body steel plates, center pillars, and bumpers, which are manufactured by pressing are improved in component strength, fracture toughness, and the like, and thus the metallic object can be utilized in realizing a further reduction in weight.

### BRIEF DESCRIPTION OF THE DRAWINGS

FIG. 1 compares tensile test results of a conventional cast material, a conventional material subjected to lamination by only additive manufacturing, and a material rolled after the lamination according to the invention (vertical axis: nominal stress σ [MPa], horizontal axis: nominal strain ε).

FIG. 2 compares Vickers hardness test results of a conventional material subjected to lamination by only additive manufacturing and a material rolled after the lamination according to the invention.

FIG. 3A is a result of the observation of a surface state of a material rolled after the lamination according to the invention by a laser microscope.

FIG. 3B is a result of the observation of a surface state of a conventional material subjected to lamination by only additive manufacturing by a laser microscope.

FIG. 4A shows a plate state after rolling when a cast material is rolled.

FIG. 4B shows a plate state after rolling when a laminated formation object obtained by additive manufacturing is rolled.

FIG. 5A is a result of the observation of an internal microstructure of a conventional material subjected to lamination only by additive manufacturing at low magnification.

FIG. 5B is a result of the observation of an internal microstructure of a material rolled after the lamination according to the invention at low magnification.

FIG. 6A is a result of the observation of an internal microstructure of a conventional material subjected to lamination by only additive manufacturing at a higher magnification than in FIG. 5A.

FIG. 6B is a result of the observation of an internal microstructure of a material rolled after the lamination according to the invention at a higher magnification than in FIG. 5B.

FIG. 7 is a result of the observation of an internal microstructure of a conventional cast material.

### EMBODIMENTS OF THE INVENTION

An embodiment of the invention will be described as follows.

When a metallic object is manufactured by solidification from a molten state as in conventional continuous casting, the cooling rate is not too high, and thus crystal grains grow up to several tens of micrometers. On the other hand, it is known that in additive manufacturing, the melting/solidification speed is very high, and thus crystal grains are fine. Accordingly, this embodiment relates to a production process for manufacturing a plate, a foil, a long object, or a bulk object having a fine internal microstructure in which an additive manufacturing with rapid melting/solidification is substituted with pouring/casting in continuous casting, and rolling, forging, and the like are employed in combination.

Since a plate, a foil, or a long object having fine crystal grains can be manufactured in the production process of this embodiment, these are thought to be higher in mechanical characteristics such as strength, ductility, and toughness than a plate, a foil, or a long object obtained by a conventional manufacturing method. Using a plate, a foil, or a long object manufactured as described above, a high value-added product which is excellent in strength and toughness can be finally manufactured. For example, the plate, the foil, or the long object can be utilized in transmission cases, brake drums, manifolds, water-cooled cylinder blocks, connecting rods, crankshafts, and the like made of an aluminum alloy as described above.

In addition, in this embodiment, effects for an improvement of surface roughness and an improvement of dimensional accuracy are also obtained by applying plastic deformation such as rolling, extrusion, and forging to a formation object manufactured by the additive manufacturing. Furthermore, not only an increase in dimensional accuracy, but also an improvement of mechanical properties resulting from work hardening and reforming by a change of the internal microstructure can be achieved by applying plastic deformation. As described above, in this embodiment, it is possible to improve the mechanical properties of a formation object in addition to an improvement of the surface roughness and the dimensional accuracy as problems in the additive manufacturing.

According to this embodiment, regarding a material (titanium and the like) which has been difficult to plastically deform in the past, a material which has a shape within a working ratio at which the working can be performed by additive manufacturing can be near net-shaped, and long objects can be continuously manufactured.

A component manufactured by conventional casting can exhibit a certain degree of strength by adjusting the elements of the material. However, it is very difficult for the component to exhibit ductility, and thus a component requiring ductility or toughness cannot be manufactured by only casting. On the other hand, in the production process of this embodiment, since an internal microstructure with fine crystal grains can be produced through an additive manufacturing, ductility or toughness can be increased in comparison to a cast material. Accordingly, according to this embodiment, a component having a performance that cannot be made by the conventional casting can be manufactured. In addition, regarding the plastic deformation, in the past, there have been limitations to a shape within a range of the working ratio at which the production can be performed due to limitations on the material shape. However, in the production process of this embodiment, by making the material shape so as to be within a working ratio at which the plastic deformation can be performed by the additive manufacturing, it is possible to manufacture a plastically deformed product having a more complicated shape than in the past. As described above, the manufacturing process of this embodiment is a process for manufacturing a component having a better performance than the conventional casting/plastic deformation.

In addition, according to this embodiment, the manufacturing process can also be applied to the manufacturing of a clad plate or a clad wire by inlaying a plurality of metallic powders in the additive manufacturing of Step 1. It is also possible to manufacture a plate or a tailored blank material embossed or molded by partially changing a plate thickness by the forging of Step 2. Furthermore, it is also possible to manufacture a hollow long object having a special internal shape.

The manufacturing process can also be applied to a continuous production process for continuously manufacturing a plate, a foil, a long object, or the like while performing the rolling, the extrusion, and the forging of Step 2 in series from the additive manufacturing of Step 1. The conventional additive manufacturing is a one-batch manufacturing method. The degree of freedom in the shape is high, but dimensions are limited, and a formation object having a length exceeding a forming area cannot be produced. However, in the manufacturing process of this embodiment, rolling, extrusion, and the like are performed immediately after the additive manufacturing, and a plate, a foil, or a long object can be continuously produced, and low productivity of the additive manufacturing can be improved.

### Examples

Hereinafter, the effects of the method for manufacturing a plate, a foil, a long object, or a bulk object according to this embodiment will be described in more detail with the method for manufacturing a plate, a foil, a long object, or a bulk object according to this embodiment. However, conditions in examples are just an example of the conditions employed to confirm the feasibility and the effects of the invention, and the invention is not limited only to the following examples. As long as the object of the invention is achieved without departing from the gist of the invention, modifications can be appropriately added and realized within a suitable scope for the intent. Accordingly, the invention can employ various conditions, and all of these are included in the technical features of the invention.

After a formation object having a plate shape was manufactured by additive manufacturing, rolling was applied as plastic deformation in a direction parallel to interfaces of laminated layers (a direction perpendicular to a lamination direction) to manufacture a plate that was a metallic product. Tensile strength of the plate before the rolling was compared to tensile strength of the plate after the rolling.

An additive manufacturing apparatus using a laser manufactured by EOS was used for the additive manufacturing. An Al—Si—Mg alloy powder having a grain diameter of 20 μm to 50 μm with a grain size distribution having a peak at a grain size of 25 μm was used as a metallic object, and the lamination direction was a thickness direction. Regarding dimensions of the formation object having a plate shape manufactured by the additive manufacturing apparatus, the width was 70 mm, the length was 210 mm, and the thickness was 7 mm. After the additive manufacturing, the formation object having a plate shape was detached from the base plate by electric discharge machining. The detached formation object having a plate shape was repeatedly rolled in a warm temperature region at 200° C. at a rolling reduction set to 0.3 mm per pass until the thickness thereof was close to a predetermined thickness of 5 mm. The rolling was completed at the time when the plate thickness was 5.05 mm. A tensile test piece was cut from the plate after the rolling by wire electric discharge machining, and a tensile test was performed. Regarding dimensions of the tensile test piece, the overall length was 50 mm, and the length of each grip portion was 15 mm. The width of a parallel portion was 15 mm and the width of a grip portion was 25 mm. The grip portion and the parallel portion were connected with an arc having a radius of 15 mm. Grinding was performed to obtain a plate thickness of 3 mm. The tensile test was performed with a method based on JIS Z 2241.

In addition, the hardness distribution of the internal portion was measured, and the internal microstructure was also observed. The surface state was observed by a laser microscope.

(Mechanical Properties)

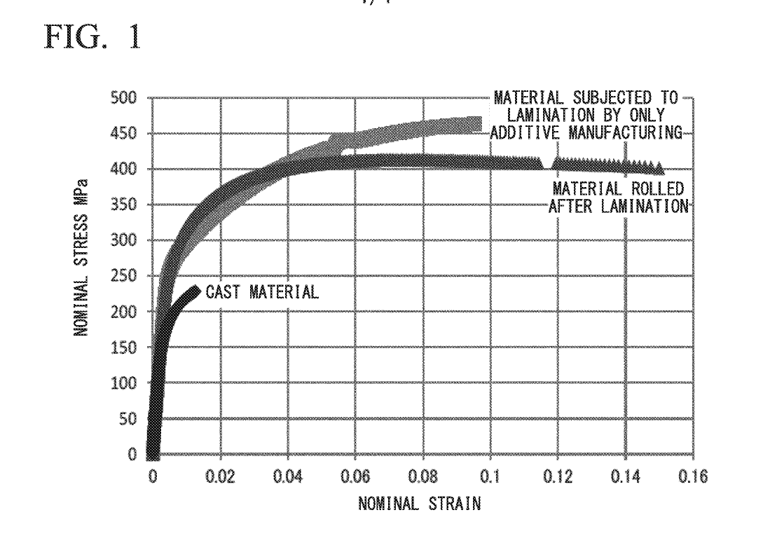

FIG. 1 shows test results of tensile test pieces cut from a plate subjected to additive manufacturing and a plate subjected to rolling. In FIG. 1, the horizontal axis indicates nominal strain, and the vertical axis indicates nominal stress [MPa]. In the case of the Al—Si—Mg alloy (see a graph of the cast material in FIG. 1) manufactured by casting, the 0.2% proof strength is 220 MPa, and the elongation is approximately 1% to 2%.

On the other hand, in the case in which the test piece was produced by additive manufacturing (see a graph of the material subjected to the lamination by only additive manufacturing in FIG. 1), the 0.2% proof strength is high, that is, 400 MPa, and the elongation is approximately 10%. In the case in which the test piece was produced by the additive manufacturing and rolling (see a graph of the material rolled after the lamination in FIG. 1), the 0.2% proof strength was 400 MPa and was almost the same as the above result, and the elongation was increased up to 15%.

The reason for this is thought to be that very fine crystal grains can be generated in the additive manufacturing.

These results show that it is possible to manufacture a bulk material having high strength and high ductility in the additive manufacturing and the rolling.

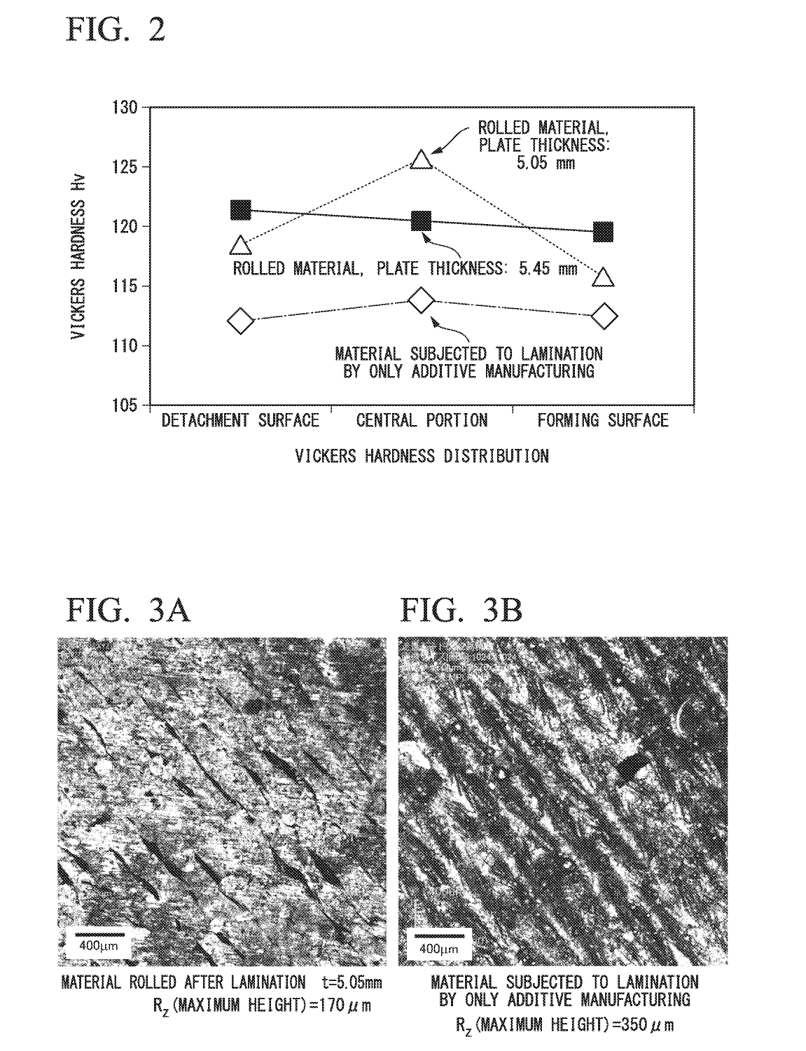

FIG. 2 show results of a Vickers hardness test. In the hardness test, a formation object was hardened with a resin, and then a cross-section of the plate was polished, and the measurement was performed at 10 points in each of both surface layers (the detachment surface and the forming surface at a depth of approximately 50 μm) of the plate and a central portion in a thickness direction. An average value was calculated in each area. The hardness measurement was targeted for a material subjected to the lamination by only additive manufacturing and a rolled material (a material rolled after the lamination, obtained by the manufacturing method according to this embodiment).

In FIG. 2, the detachment surface is a surface detached from the base, and the forming surface is an upper surface after the formation. From the results thereof, it is found that the rolled material (the material rolled after the lamination, obtained by the manufacturing method according to this embodiment) exhibit slightly high hardness.

(Surface Roughness: Irregularities)

FIG. 3A shows a micrograph of a surface state of the material rolled after the lamination (finishing to a plate thickness t of 5.05 mm by rolling), and FIG. 3B shows a micrograph of a surface state of the material subjected to the lamination by only additive manufacturing. The observation visual field was 2.4 mm×2.4 mm, and the magnification was 100 times. The surface of the plate subjected to the additive manufacturing shown in FIG. 3B has traces of laser scanning, and is coarse with large irregularities.

On the other hand, the plate after the rolling had a good surface state as shown in FIG. 3A. The reason for this is that the surface is smoothened by the rolling. It was confirmed that when a laminated formation object is rolled as described above, the surface state thereof is greatly improved. The surface roughness after the rolling is smooth surface roughness that cannot be achieved by only the additive manufacturing.

The surface roughness was measured based on JIS B 0601. In the case of the material subjected to the lamination by only additive manufacturing in FIG. 3B, a maximum height Rz, that is a surface roughness index indicating a difference between an area where the surface roughness is the maximum and an area where the surface roughness is the minimum in the observation range, was 350 μm.

On the other hand, in the case of the plate rolled after the lamination in FIG. 3A, a state in which irregularities of forming traces shown in the material subjected to the lamination by only additive manufacturing were crushed, and thus the plate became smooth was observed. The maximum height Rz was 170 μm, and is reduced by half compared to that of the material subjected to the lamination by only additive manufacturing.

(Surface Roughness: Cracking)

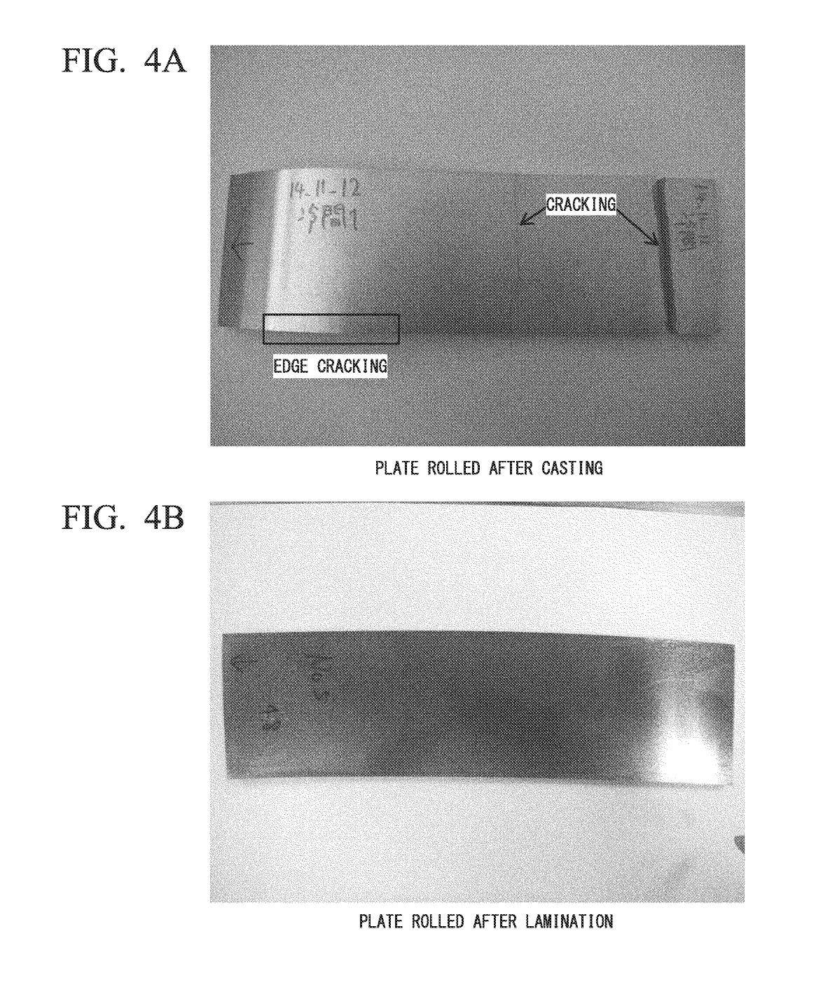

FIGS. 4A and 4B show plates obtained by rolling a plate produced by casting and a plate produced by additive manufacturing. The arrows in the drawings indicate a rolling direction. Dimensions of the cast material before the rolling were the same as those of the object obtained by the additive manufacturing. The width was 70 mm, the length was 210 mm, and the thickness was 7 mm.

The plate produced by casting in FIG. 4A was broken during the rolling, but the plate produced by the additive manufacturing in FIG. 4B is rolled without the occurrence of cracking. In the plate produced by casting, cracking (edge cracking) occurs at edges of the plate, but in the plate obtained by the additive manufacturing, edge cracking does not occur.

(Refinement of Microstructure)

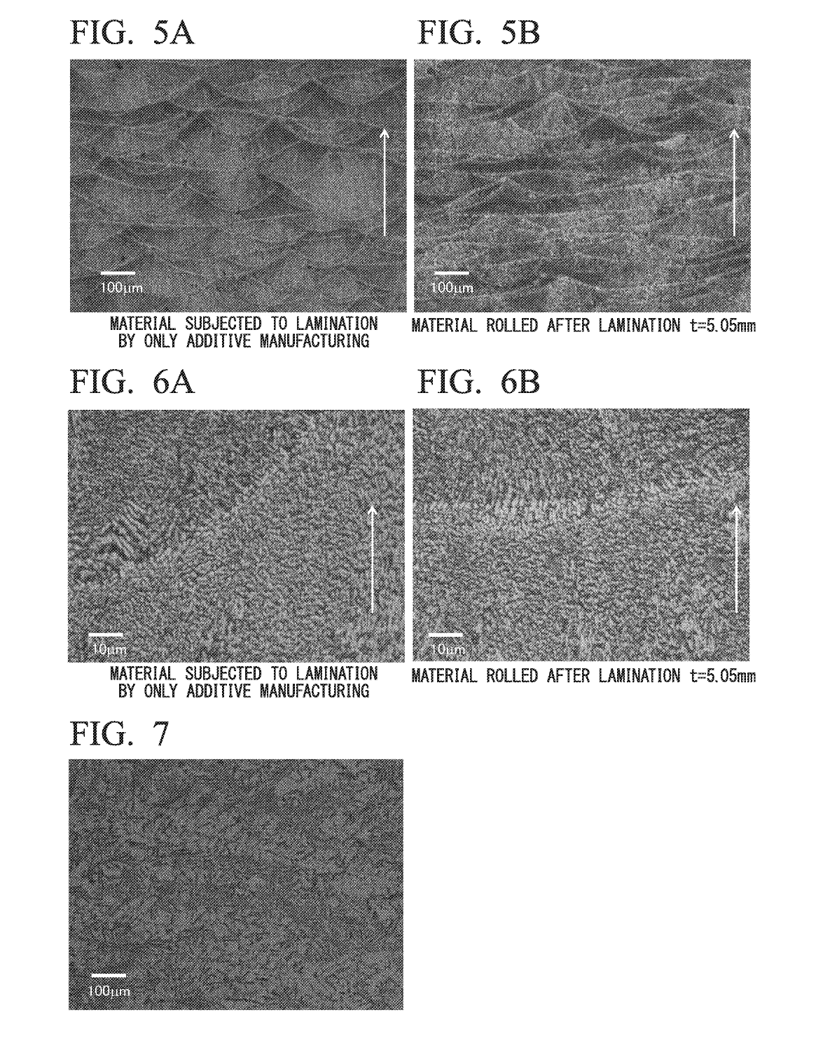

FIGS. 5A and 6A show photographs for observing internal microstructures of cross-sections of materials subjected to the lamination by only additive manufacturing, and FIGS. 5B and 6B show photographs for observing internal microstructures of cross-sections of materials rolled after the lamination. In the internal microstructure observation, a formation object is polished and etched with aqueous sodium hydroxide after being hardened with a resin, and the resulting sample was observed by an optical microscope. When low magnification is used, it is 100 times, and when high magnification is used, it is 500 times. The arrows in the drawings indicate a lamination direction.

In the results at low magnification in FIGS. 5A and 5B, a flaky pattern can be observed. This is thought to be a result of the rapid melting and solidification when laser scanning is performed in the additive manufacturing. This flaky pattern is not crystal grains.

In the results at high magnification in FIGS. 6A and 6B, it could be observed that fine grains shown in a flaky pattern were crystal grains. The size of crystal grains is approximately several micrometers, and very fine crystal grains are obtained. In addition, this internal microstructure can be confirmed to be maintained even when being subjected to rolling.

On the other hand, FIG. 7 shows a result of the observation of an internal microstructure of a cast material for comparison. It can be confirmed that dendrites are developed and crystal grains of several tens of micrometers or more are formed. As above, the internal microstructure in the casting is very different from that in the additive manufacturing.

### INDUSTRIAL APPLICABILITY

A manufacturing method of the invention can be used as a process for manufacturing a metallic object having a plate shape, a foil shape, a long object shape, or a bulk object shape by performing plastic deformation after manufacturing a formation object from a metallic powder material by additive manufacturing, and thus has high industrial applicability.

1. A method for manufacturing one of a group consisting of a plate, a foil, a long object, and a bulk object, comprising:
Step 1 of manufacturing a formation object having a shape selected from a group consisting of a plate shape, a foil shape, a long object shape, and a bulk object shape, using a metallic powder material by an additive manufacturing; and
Step 2 of manufacturing the formation object into one of the group consisting of the plate, the foil, the long object, and the bulk object, by a plastic deformation.

2. The method for manufacturing one of the group consisting of the plate, the foil, the long object, and the bulk object according to claim 1,
wherein the plastic deformation is one or a combination of two or more of a rolling, an extrusion, and a forging.

3. The method for manufacturing one of a group consisting of the plate, the foil, the long object, and the bulk object according to claim 1,
wherein dimensions of the formation object of Step 1 are obtained by near net-shaping the formation object to be dimensions within a working ratio at which the formation object can be worked by the plastic deformation of Step 2.

4. One of a group consisting of a plate, a foil, a long object, and a bulk object which is manufactured by the manufacturing method according to any one of claims claim 1.
